(19) United States
(12) Patent Application Publication
(10) Pub. No.: US 2026/0369794 A1
(43) Pub. Date: Nov. 19, 2026

(54) BATTERY APPARATUS AND ELECTRICAL DEVICE

(71) Applicant: CONTEMPORARY AMPEREX TECHNOLOGY CO., LIMITED, Ningde (CN)

(72) Inventors: Jun MA, Ningde (CN); Jun LIU, Ningde (CN); Jiangming LIU, Ningde (CN); Cancan LI, Ningde (CN)

(21) Appl. No.: 19/345,882

(22) Filed: Sep. 30, 2025

Related U.S. Application Data
(63) Continuation of application No. PCT/CN2025/105969, filed on Jun. 30, 2025.

(30) Foreign Application Priority Data
May 16, 2025 (CN) 202510637209.7

(51) Int. Cl. H01M 50/291; B60L 50/64; H01M 10/613; H01M 10/625; H01M 10/647; H01M 10/653; H01M 10/6556; H01M 50/209; H01M 50/317; H01M 50/342

(52) U.S. Cl. CPC H01M 50/291; H01M 10/613; H01M 10/625; H01M 10/647; H01M 10/653; H01M 10/6556; H01M 50/209; H01M 50/317; H01M 50/3425; B60L 50/64; H01M 2200/20; H01M 2220/20

(57) ABSTRACT

A battery apparatus and an electrical device. The battery apparatus includes a battery cell and a position-limiting assembly. The battery cell includes an electrode terminal, and the electrode terminal is arranged at one end of the battery cell in a first direction. The position-limiting assembly includes a supporting member, in the first direction, the supporting member is located on a side of the electrode terminal facing away from the other end of the battery cell in the first direction, the supporting member has a first cavity, and the first cavity is configured to allow a first heat exchange medium to flow. In a same projection plane perpendicular to the first direction, an orthographic projection of the electrode terminal and an orthographic projection of the first cavity are spaced apart.

### CROSS-REFERENCE TO RELATED APPLICATIONS

The present application is a continuation of International Application No. PCT/CN2025/105969, filed on Jun. 30, 2025, which claims priority to Chinese Patent Application No. 202510637209.7, entitled “BATTERY APPARATUS AND ELECTRICAL DEVICE” and filed on May 16, 2025, which are incorporated herein by reference in their entirety.

### TECHNICAL FIELD

The present application relates to the field of battery technologies, and more specifically relates to a battery apparatus and an electrical device.

### BACKGROUND

With the development of new-energy technologies, battery apparatuses are increasingly widely applied, such as applied in a mobile phone, a laptop, a storage battery car, an electric vehicle, an electric airplane, an electric ship, an electric toy car, an electric toy ship, an electric toy plane, an electric tool, and the like.

In the development of battery technologies, how to balance the performance and reliability of battery apparatuses is an urgent technical issue to be addressed in the battery technologies.

### SUMMARY

In view of the above problems, the present application provides a battery apparatus and an electrical device, which can improve the reliability of the battery apparatus while improving the performance of the battery apparatus.

In a first aspect, the present application provides a battery apparatus, including: a battery cell, including an electrode terminal, where the electrode terminal is arranged at one end of the battery cell in a first direction; a position-limiting assembly, including a supporting member, where in the first direction, the supporting member is located on a side of the electrode terminal facing away from the other end of the battery cell in the first direction, the supporting member has a first cavity, and the first cavity is configured to allow a first heat exchange medium to flow; where in a same projection plane perpendicular to the first direction, an orthographic projection of the electrode terminal and an orthographic projection of the first cavity are spaced apart.

In some embodiments of the first aspect, the first cavity of the supporting member is configured to allow the first heat exchange medium to flow, so that the supporting member can perform heat exchange with the battery cell to perform thermal management on the battery cell. By arranging the supporting member on the side of the battery cell facing the electrode terminal, the supporting member is capable of directly cooling the heat in a region near the electrode terminal, and reducing the occurrence of heat diffusion to the surrounding region, and is capable of better improving the cooling effect and uniformity of the battery cell, thereby being conducive to improving the performance of the battery cell, and further improving the performance of the battery apparatus. In addition, by staggering the electrode terminal and the first cavity, the possibility of interference between the two is capable of being effectively reduced, thereby reducing the possibility of a safety problem such as electrical connection, so as to improve the reliability of the battery apparatus.

In some embodiments, the first direction is a height direction of the battery cell. In the first direction, the battery cell has a top end and a bottom end that are oppositely arranged. The electrode terminal is arranged at the bottom end of the battery cell, and the battery cell is supported by the supporting member.

In the above technical solution, the electrode terminal is arranged at the bottom end of the battery cell, and the supporting member having the first cavity is also located at the bottom end of the battery cell, so that the supporting member can provide thermal management for the battery cell as well as support and protection functions, which is conducive to better improving the performance and reliability of the battery apparatus.

In some embodiments, the supporting member includes a first supporting portion and a second supporting portion interconnected in a second direction, the first supporting portion has a first cavity, and in the first direction, the battery cell and the second supporting portion are spaced apart, and a side surface of the first supporting portion facing the battery cell protrudes from a side surface of the second supporting portion facing the battery cell, and the first direction intersects with the second direction.

In the above technical solution, the layout is reasonable, the second supporting portion is spaced apart from the battery cell, and it can also prevent the second supporting portion from interfering with the electrode terminal and causing safety problems.

In some embodiments, on the same projection plane perpendicular to the first direction, the orthographic projection of the electrode terminal and an orthographic projection of the first supporting portion are spaced apart.

In the above technical solution, the possibility of interference between the electrode terminal and the first supporting portion is reduced, thereby facilitating the improvement of the reliability of the battery apparatus.

In some embodiments, the battery apparatus further includes a first heat-conducting structure, the first heat-conducting structure is arranged between the first supporting portion and the battery cell, and the battery cell is connected to the first supporting portion through the first heat-conducting structure.

In the above technical solution, by arranging the first heat-conducting structure, it is conducive to improving the heat exchange efficiency between the first supporting portion and the battery cell, and also conducive to improving the connection strength between the two.

In some embodiments, there are a plurality of supporting members, the plurality of supporting members are welded in sequence in the second direction, and the first supporting portion and the second supporting portion in each of the supporting members are an integrated structure. The above arrangement facilitates processing and forming, and is also conducive to improving the connection strength between the two.

In some embodiments, in the first direction, a groove is provided on a side of the second supporting portion facing the battery cell, and the orthographic projection of the electrode terminal falls into the groove.

In the above technical solution, since the temperature changes in the process of the first supporting portion performing thermal management on the battery cell, a temperature difference will be generated with the surrounding environment, and condensation water may be easily generated on a surface of the first supporting portion. By providing the groove on the side of the second supporting portion facing the electrode terminal, the condensation water can follow the trend to flow downward into the groove, thereby reducing the possibility of safety problems caused by contact between the electrode terminal and the condensation water.

In some embodiments, in the first direction, the second supporting portion has a first surface and a second surface that are oppositely arranged, the first surface is arranged facing the battery cell, the groove is recessed from the first surface toward the second surface, and a protruding portion protruding from the second surface is formed at a position of the second supporting portion corresponding to the groove.

In the above technical solution, in the process of forming the groove, the second supporting portion further forms the protruding portion opposite to the groove in the first direction, which is capable of making thicknesses of various positions of the second supporting portion tend to be consistent, thereby being conducive to reducing costs.

In some embodiments, the second supporting portion has a via hole in communication with the groove.

In the above technical solution, the condensation water generated on the surface of the first supporting portion is capable of being collected in the groove and flowing out through the via hole, which is conducive to better reducing the possibility of contact between the electrode terminal and the condensation water.

In some embodiments, on the same projection plane perpendicular to the first direction, the orthographic projection of the electrode terminal overlaps with an orthographic projection of the via hole. The above arrangement is capable of better reducing the possibility of contact between the electrode terminal and the condensation water.

In some embodiments, the battery apparatus further includes a box body, and the battery cell and the supporting member are both arranged in the box body. The box body includes a bottom plate. In the first direction, the bottom plate is arranged on a side of the supporting member facing away from the battery cell, and there is a gap between the via hole and the bottom plate.

In the above technical solution, the box body is capable of protecting the battery cell and the supporting member to improve the reliability of the battery apparatus, and the condensation water flowing out of the via hole is capable of flowing to a position between the bottom plate and the second supporting portion, which is capable of reducing the possibility of the condensation water flowing out of the box body, so as to reduce the possibility of interference with the external environment.

In some embodiments, the battery apparatus further includes a drying assembly. In the first direction, the drying assembly is arranged between the second supporting portion and the bottom plate, and the orthographic projection of the via hole falls in the drying assembly.

In the above technical solution, the drying assembly is capable of absorbing the condensation water flowing out of the via hole to maintain a dry environment in the box body, which is conducive to improving the reliability of the battery apparatus.

In some embodiments, the box body further includes a frame, the frame is welded to the supporting member and they enclose to form an accommodating space, and the battery cell is accommodated in the accommodating space.

In the above technical solution, it is conducive to improving the connection strength between the supporting member and the box body, thereby being conducive to improving the structural strength and service life of the supporting member, and further conducive to improving the reliability of the battery apparatus.

In some embodiments, the bottom plate is connected to the frame; and/or, in the first direction, there is a gap between the supporting member and the bottom plate.

In the above technical solution, the bottom plate may be connected to the frame and may also be spaced apart from the supporting member. When the bottom plate is subjected to a force such as an impact or a vibration, it is conducive to improving the protection effect of the supporting member, thereby improving the reliability of the battery apparatus.

In some embodiments, the battery cell further includes a pressure relief mechanism. In the first direction, the pressure relief mechanism is arranged at one end of the battery cell facing the electrode terminal, and the pressure relief mechanism is configured to discharge an emission within the battery cell. In the same projection plane perpendicular to the first direction, an orthographic projection of the pressure relief mechanism is spaced apart from the orthographic projection of the first cavity.

In the above technical solution, the possibility of interference between the emission discharged by the pressure relief mechanism and the first cavity is capable of being reduced, so as to reduce the phenomenon that when a battery cell has thermal runaway, the emission discharged by the pressure relief mechanism impacts the first cavity and causes damage to the first cavity.

In some embodiments, the second supporting portion is provided with a weak portion, and the weak portion and the pressure relief mechanism are arranged oppositely in the first direction.

In the above technical solution, the emission discharged by the pressure relief mechanism is capable of being discharged from the weak portion to be released, so as to reduce the risk of cracking of the second supporting portion.

In some embodiments, the weak portion is a discharge hole passing through the second supporting portion. The above arrangement is conducive to quickly discharging the emission.

In some embodiments, the battery apparatus further includes a blocking member. The blocking member is connected to a side of the second supporting portion facing the battery cell in the first direction, and the blocking member covers the discharge hole. The blocking member is configured to be actuated by the emission discharged from the corresponding battery cell toward the discharge hole, so as to open the discharge hole.

In the above technical solution, the blocking member is capable of preventing leakage of electrolyte or intrusion of particles such as foreign impurities, so as to improve the reliability of the battery apparatus.

In some embodiments, the blocking member includes a blocking portion and a connecting portion, the connecting portion is connected to the second supporting portion, the blocking portion protrudes from the connecting portion in the first direction toward a side facing away from the battery cell, and the blocking portion extends into the discharge hole.

In the above technical solution, the blocking member is arranged as a stepped structure, and therefore, the blocking portion can be actuated more quickly under the impact of the emission, so that the discharge hole is opened.

In some embodiments, the battery apparatus further includes a flexible assembly, the flexible assembly is arranged between the battery cell and the second supporting portion and encloses, together with the battery cell and the second supporting portion, a discharge channel, and the pressure relief mechanism is in communication with the weak portion through the discharge channel. The above arrangement is capable of reducing the possibility of the emission spreading to other locations.

In some embodiments, a reinforcement structure is protruded from at least one side of the supporting member in the first direction. The above arrangement is conducive to improving the structural strength of the supporting member.

In some embodiments, the position-limiting assembly further includes a plurality of position-limiting members. In the first direction, the plurality of position-limiting members are connected to a side of the supporting member facing the battery cell. The plurality of position-limiting members are arranged in the second direction. The battery cell is arranged between two adjacent position-limiting members and fixed by the position-limiting members. The first direction intersects with the second direction.

In the above technical solution, the position-limiting member is capable of limiting the movement of the battery cell in the second direction, which is convenient for mounting and positioning, and is further conducive to reducing the possibility of displacement of the battery cell.

In some embodiments, the position-limiting member has a second cavity, and the second cavity is configured to allow a second heat exchange medium to flow.

In the above technical solution, the position-limiting member can not only play the role of positioning and position-limiting, but also perform thermal management on the battery cell, which is conducive to further improving the performance of the battery apparatus.

In some embodiments, the position-limiting members each include a first position-limiting portion and a second position-limiting portion, the battery cell is arranged between two adjacent first position-limiting portions, in the first direction, the second position-limiting portion is connected to a side of the first position-limiting portion facing away from the supporting member, and at least one side of the second position-limiting portion in the second direction protrudes from the first position-limiting portion.

In the above technical solution, the second position-limiting portion is capable of position-limiting the movement of the battery cell in the first direction away from the side where the supporting member is located, which is conducive to improving the reliability of the battery apparatus.

In some embodiments, in the first direction, the second position-limiting portion abuts against the end of the battery cell facing away from the electrode terminal. The above arrangement is capable of better position-limiting the battery cell.

In some embodiments, a size of the battery cell in the second direction is D, and in the second direction, a size of a part of the second position-limiting portion covering the battery cell in the first direction is L, where 1/100≤D/L≤1/5.

The above arrangement is conducive to improving the effectiveness of the second position-limiting portion in position-limiting the battery cell.

In some embodiments, 3/200≤D/L≤3/20. The above arrangement is capable of further improving the position-limiting effect of the second position-limiting portion on the battery cell in the first direction.

In some embodiments, the first position-limiting portion and the second position-limiting portion are an integrated structure, and/or the first position-limiting portion and the supporting member are an integrated structure, and/or the first position-limiting portion, the second position-limiting portion, and the supporting member are an integrated structure.

The above arrangement is conducive to improving the structural strength of the position-limiting assembly and is further conducive to improving the use flexibility of the position-limiting assembly.

In a second aspect, the present application provides an electrical device, including the battery apparatus provided in any one of the embodiments of the first aspect.

The above illustrations are merely brief descriptions for the technical solutions of the present application. Specific implementation manners of the present application are described specifically in the following to understand the technical solutions of the present application more clearly and implement the present application according to content of the specification, and to make the above and other objectives, features and advantages of the present application more comprehensible.

### BRIEF DESCRIPTION OF DRAWINGS

In order to illustrate the technical solutions of the embodiments of the present application more clearly, the drawings required in the embodiments of the present application are briefly introduced below. Apparently, the drawings described below are only some embodiments of the present application. For those of ordinary skill in the art, other drawings can also be obtained according to the drawings without involving any creative effort.

FIG. 1 is a schematic structural view of a vehicle according to some embodiments of the present application;

FIG. 2 is a schematic structural view of a battery cell assembly according to some embodiments of the present application;

FIG. 3 is an exploded schematic structural view of a battery cell according to some embodiments of the present application;

FIG. 4 is a partial schematic structural view of a battery apparatus according to some embodiments of the present application;

FIG. 5 is an exploded schematic structural diagram of the battery apparatus in FIG. 4;

FIG. 6 is a partial sectional view of a battery apparatus according to some embodiments of the present application;

FIG. 7 is a schematic structural view of a position-limiting assembly in a battery apparatus according to some embodiments of the present application;

FIG. 8 is an enlarged view of a portion P in FIG. 7;

FIG. 9 is an enlarged view of a portion Q in FIG. 8;

FIG. 10 is an enlarged view of a portion T in FIG. 6; and

FIG. 11 is a partial sectional view of a battery apparatus according to other embodiments of the present application.

Reference numerals in Detailed Description are as follows:

100. Vehicle; 1. Battery apparatus; 2. Controller; 3. Motor; 4. Battery cell assembly;

10. Battery cell, 101. Top end; 102. Bottom end; 11. Shell; 111. End cover; 112. Case; 12. Electrode assembly; 13. Electrode terminal; 14. Pressure relief mechanism;

20. Position-limiting assembly; 21. Supporting member; 201. First cavity; 211. First supporting portion; 212. Second supporting portion; 2121. First surface; 2101. Groove; 2122. Second surface; 2102. Protruding portion; 202. Reinforcement structure; 203. Discharge hole;

22. Position-limiting member; 221. First position-limiting portion; 222. Second position-limiting portion;

30. Box body; 31. Bottom plate; 32. Frame;

41. First heat-conducting structure; 42. Drying assembly; 44. Blocking member; 441. Blocking portion; 442. Connecting portion; 45. Flexible assembly; 451. Discharge channel;

X. First direction; Y. Second direction; and Z. Third direction.

### DETAILED DESCRIPTION

In order to make the objects, technical solutions and advantages of embodiments of the present application clearer, the technical solutions in the embodiments of the present application will be clearly described below with reference to the drawings for the embodiments of the present application. Apparently, the described embodiments are some of, rather than all of, the embodiments of the present application. All other embodiments obtained by those of ordinary skill in the art based on the embodiments in the present application without any creative effort shall fall within the scope of protection of the present application.

Unless otherwise defined, all technical and scientific terms used in the present application have the same meanings as those commonly understood by those skilled in the art to which the present application belongs. The terms used in the specification of the present application are merely for the purpose of describing specific embodiments, but are not intended to limit the present application. The terms “include” and “have” and any variations thereof in the specification and the claims of the present application as well as the above description of the drawings are intended to cover non-exclusive inclusions. The terms “first,” “second,” and the like in the specification and the claims of the present application as well as the above drawings are used to distinguish different objects, rather than to describe a specific order or primary-secondary relationship.

Reference in the present application to an “embodiment” means that a particular feature, structure, or characteristic described in connection with the embodiment can be included in at least one embodiment of the present application. The appearance of this phrase in various places in the specification does not necessarily refer to the same embodiment, nor is it a separate or alternative embodiment that is mutually exclusive with other embodiments.

In the description of the present application, it should be noted that the terms “mounting”, “connecting”, “connection”, and “attachment” should be understood in a broad sense, unless otherwise explicitly specified or defined, for example, it may be a fixed connection, a detachable connection or an integrated connection; and may be a direct connection or an indirect connection through an intermediate medium, or may be a communication between the interior of two elements. For those of ordinary skill in the art, the specific meanings of the above terms in the present application can be understood according to specific situations.

In the present application, the term “and/or” is merely an association that describes the associated object, indicating that there can be three kinds of relationships, for example, A and/or B may denote the following three situations: A exists alone, A and B exist at the same time, and B exists alone. In addition, the character “/” in the present application generally means that the associated objects before and after it are in an “or” relationship. In this disclosure, unless otherwise specified, phrases like “at least one of A, B, and C” and “at least one of A, B, or C” both mean only A, only B, only C, or any combination of A, B, and C.

In the embodiments of the present application, the same reference numerals denote the same components, and for the sake of brevity, detailed descriptions of the same components are omitted in different embodiments. It should be understood that the thickness, length, width and other dimensions of the various components in the embodiments of the present application shown in the drawings, as well as the overall thickness, length, width and other dimensions of an integrated apparatus, are for illustrative purposes only, and should not constitute any limitation to the present application.

In the present application, the “plurality of” refers to more than two (including two).

At present, from the development of market situation, the application of battery apparatuses is becoming increasingly more extensive. Battery apparatuses are not only used in energy storage power systems such as hydropower, thermal power, wind power, and solar power stations, but also widely used in electric vehicles such as electric bicycles, electric motorcycles, and electric vehicles, as well as aerospace and other fields. With the continuous expansion of the application field of battery apparatuses, the market demand thereof is also constantly expanding.

In the embodiments of the present application, the battery cell may be a secondary battery. The secondary battery refers to a battery cell that, after the battery cell is discharged, can activate an active material by charging for continued use.

The battery cell may be a lithium-ion battery, a sodium-ion battery, a sodium/lithium-ion battery, a lithium metal battery, a sodium metal battery, a lithium-sulfur battery, a magnesium-ion battery, a nickel-hydrogen battery, a nickel-cadmium battery, a lead storage battery, or the like, which is not limited in the embodiments of the present application.

The battery apparatus will generate a large amount of heat during charging and discharging, and the heat is more concentrated in a tab region. Since a tab and a cold plate structure will interfere with each other, safety problems such as electrical connection are likely to occur. Therefore, in the related technology, a cold plate structure is usually arranged on a side surface or a bottom surface of the battery cell away from the tab. Although it can achieve a certain cooling effect, the effect is not desirable, and it is easy to cause uneven temperature distribution of the battery cell, thereby reducing the performance of the battery cell, and even causing thermal runaway.

Based on the above technical problem, the present application provides a battery apparatus, including a battery cell and a position-limiting assembly. The battery cell includes an electrode terminal, and the electrode terminal is arranged at one end of the battery cell in a first direction. The position-limiting assembly includes a supporting member, and in the first direction, the supporting member is located on a side of the electrode terminal facing away from the other end of the battery cell in the first direction, the supporting member has a first cavity, and the first cavity is configured to allow a first heat exchange medium to flow. In a same projection plane perpendicular to the first direction, an orthographic projection of the electrode terminal and an orthographic projection of the first cavity are spaced apart.

By arranging the supporting member having the first cavity on the side of the battery cell facing the electrode terminal, the supporting member is capable of directly cooling the heat in a region near the electrode terminal, so as to reduce the possibility of heat diffusion to the surrounding region, and to be capable of better improving the cooling effect and uniformity of the battery cell, thereby being conducive to improving the performance of the battery cell, and further improving the performance of the battery apparatus. In addition, by staggering the electrode terminal and the first cavity, the possibility of interference between the two is capable of being effectively reduced, thereby reducing the possibility of a safety problem such as electrical connection, and being conducive to improving the reliability of the battery apparatus.

The technical solutions described in the embodiments of the present application are all applicable to various electrical devices using battery apparatuses, such as mobile phones, portable devices, laptops, battery vehicles, electric toys, electric tools, vehicles, ships, spacecrafts, and the like. For example, the spacecrafts include airplanes, rockets, space shuttles, spaceships, and the like.

It should be understood that the technical solutions described in the examples of the present application are not only applicable to the devices described above, but also applicable to all devices using battery apparatuses. However, for the sake of brevity, the following embodiments are described by taking an electric vehicle as an example.

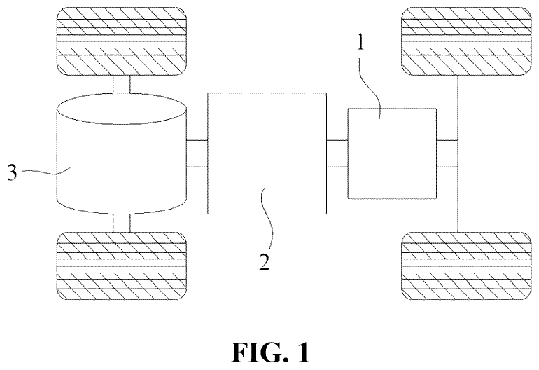

For example, as shown in FIG. 1, FIG. 1 is a schematic structural view of a vehicle 100 according to an embodiment of the present application. The vehicle 100 may be a fuel vehicle, a gas vehicle, or a new energy vehicle, and the new energy vehicle may be an all-electric vehicle, a hybrid vehicle, an extended range electric vehicle, or the like. A motor 3, a controller 2, and a battery apparatus 1 may be arranged inside the vehicle 100, and the controller 2 is configured to control the battery apparatus 1 to supply power to the motor 3. For example, the battery apparatus 1 may be arranged at the bottom or head or tail of the vehicle 100. The battery apparatus 1 may be configured to supply power to the vehicle 100, for example, the battery apparatus 1 may be used as an operating power source of the vehicle 100, which is used for a circuit system of the vehicle 100, for example, for operation power requirements of the vehicle 100 during starting, navigation, and running. In another embodiment of the present application, the battery apparatus 1 may be used not only as an operating power source of the vehicle 100, but also as a driving power source of the vehicle 100, replacing or partially replacing fuel or natural gas to provide driving power for the vehicle 100.

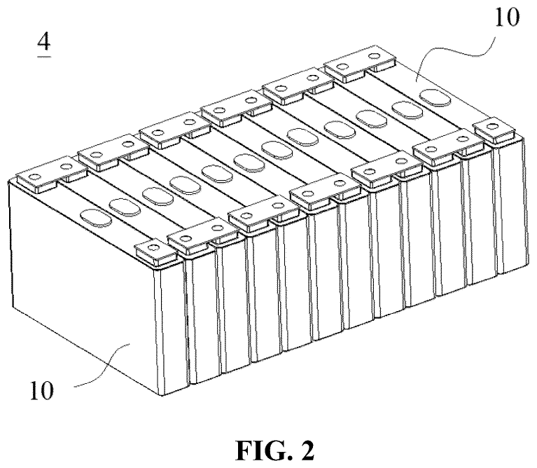

Referring to FIG. 2, the battery apparatus 1 mentioned in an embodiment of the present application may include one or a plurality of battery cell assemblies 4, for providing a voltage and a capacity. The battery cell assembly 4 may include a plurality of battery cells 10, and the plurality of battery cells 10 are connected in series, in parallel, or in parallel-series through a busbar component.

In some embodiments, the battery cell assembly 4 is generally formed by arranging a plurality of battery cells 10.

As an example, the battery cell assembly 4 may be a battery module, and the battery module may be formed by a plurality of battery cells 10 arranged and fixed to form an independent module. As an example, the battery module may be formed by bundling a plurality of battery cells 10 through a cable tie.

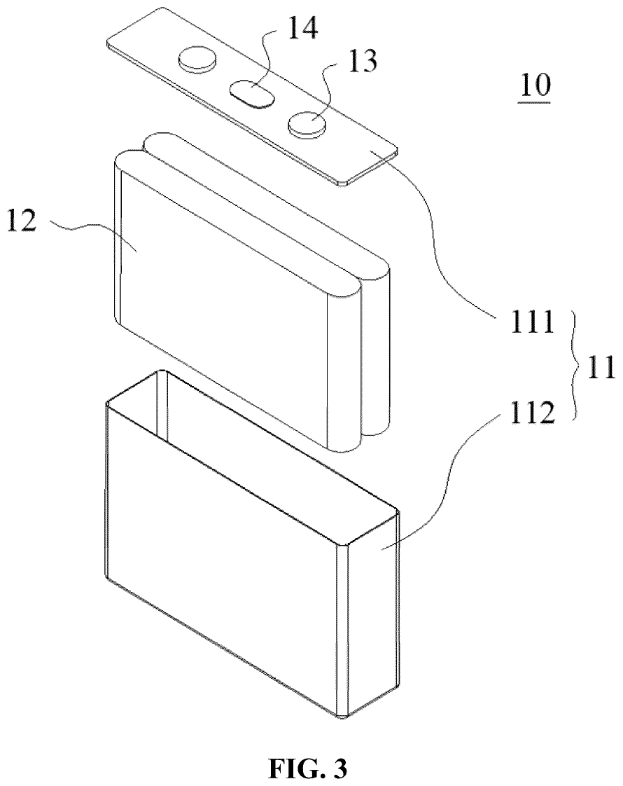

Referring to FIG. 3, the battery cell 10 includes a shell 11 and an electrode assembly 12.

The shell 11 is an component configured to form an internal environment of the battery cell 10, where the formed internal environment can be used for accommodating the electrode assembly 12, an electrolyte solution, and other components. Optionally, the shell 11 may be, but not limited to, made of a material such as a metallic or non-metallic material. For example, the metallic material can be copper, aluminum, stainless steel, or the like; and the non-metallic material may be polyethylene, polypropylene, polyvinyl chloride, or the like.

The shell 11 may be a steel shell, an aluminum shell, a plastic shell (e.g., polypropylene), a composite metal shell (e.g., a copper-aluminum composite shell), or an aluminum-plastic film, or the like.

In some embodiments, the shell 11 may be a sealed structure or a non-sealed structure. As an example, when the shell 11 is a non-sealed structure, the shell 11 can protect the electrode assembly 12. A sealing bag is also included between the shell 11 and the electrode assembly 12, and the sealing bag is configured to encapsulate the electrode assembly 12 and an electrolyte. Specifically, the sealing bag may be a bag-shaped insulating member or an aluminum-plastic film. The shell 11, when being a sealed structure, is configured to encapsulate components such as the electrode assembly 12 and the electrolyte.

In some implementations, the shell 11 includes an end cover 111 and a case 112, the case 112 is provided with a case opening, and the end cover 111 covers the case opening. The case 112 may be provided with one or a plurality of case openings. One or a plurality of end covers 111 may also be provided.

The shape of the shell 11 may be determined according to a specific shape of the electrode assembly 12. For example, if the electrode assembly 12 is of a cuboid structure, a cuboid shell can be selected; and if the electrode assembly 12 is of a cylindrical structure, a cylindrical shell can be selected.

The electrode assembly 12 is a component in the battery cell 10 that undergoes electrochemical reactions, and the shell 11 may include one or more electrode assemblies 12.

In some implementations, the electrode assembly 12 may be cylindrical, flat, polyprismatic, or the like.

The electrode assembly 12 may be a wound structure, a laminated structure, or a mixed structure of a wound structure and a laminated structure.

The electrode assembly 12 includes a positive electrode, a negative electrode, and a separator. The separator is arranged between the positive electrode and the negative electrode. During charging and discharging of the battery cell 10, active ions (e.g., lithium ions) are intercalated and de-intercalated back and forth between the positive electrode and the negative electrode. The spacer is arranged between the positive electrode and the negative electrode, and functions to prevent a short circuit between the positive electrode and the negative electrode while enabling the active ions to pass through.

As shown in FIG. 3, the battery cell 10 further includes an electrode terminal 13.

The electrode terminal 13 may be arranged on the shell 11. Optionally, the end cover 111 may be provided with an electrode terminal 13, or the case 112 may be provided with an electrode terminal 13, or both the end cover 111 and the case 112 may be provided with an electrode terminal 13.

In some implementations, the shell 11 is provided with at least one electrode terminal 13, and the electrode terminal 13 is electrically connected to a tab of the electrode assembly 12. The electrode terminal 13 can be directly connected to the tab, or can also be indirectly connected to the tab through an current collecting member.

The electrode terminal 13 can be configured to be electrically connected to the electrode assembly 12, for outputting or inputting electric energy from or into the battery cell. The electrode terminal 13 may be connected to the tab, so as to implement its electrical connection wit the electrode assembly 12. The tab electrically connected to the electrode terminal 13 may be a positive electrode tab or a negative electrode tab.

As an example, the battery cell 10 may be a cylindrical battery cell, a prismatic battery cell, a pouch cell, or a battery cell in another shape. The prismatic battery cell includes a square-shell battery cell, a blade-shaped battery cell, and a multi-prism battery. For example, the multi-prism battery may be a hexagonal prism battery.

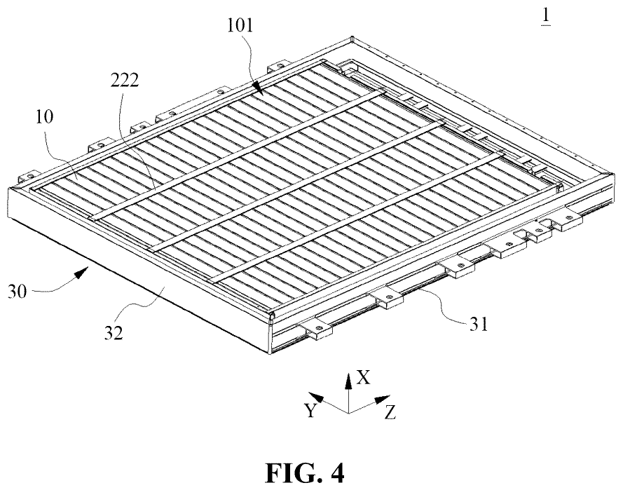

Referring to FIG. 4, in some embodiments, the battery apparatus 1 may be a battery pack. The battery pack includes a box body 30 and one or a plurality of battery cell assemblies 4. The battery cell assembly 4 is accommodated in the box body 30.

As an example, the battery cell assembly 4 may be a battery module, and the battery cell assembly 4 may be accommodated in the box body 30 by fixing the battery module in the box body 30.

As an example, the battery cell assembly 4 may also be accommodated in the box body 30 by directly fixing the plurality of battery cells 10 to the box body 30.

In some embodiments, the box body 30 may be a part of a chassis structure of a vehicle 100. For example, a part of the box body 30 may become at least a part of a floor of the vehicle 100, or a part of the box body 30 may become at least a part of a cross beam and a longitudinal beam of the vehicle 100.

The box body 30 may be a simple three-dimensional structure such as an independent cuboid or cylinder, and may also be a complex three-dimensional structure formed by combining simple three-dimensional structures such as cuboids or cylinders, which is not limited in the embodiments of the present application.

Specifically, the box body 30 may be a metal case made of alloy steel, alloy aluminum, or the like, or a composite material case made of metal, polypropylene, and the like.

Referring to FIG. 3 to FIG. 6 together, according to an embodiment of the present application, a battery apparatus 1 is provided, including a battery cell 10 and a position-limiting assembly 20. The battery cell 10 includes an electrode terminal 13. One end of the battery cell 10 in a first direction X is provided with the electrode terminal 13. The position-limiting assembly 20 includes a supporting member 21, and in the first direction X, the supporting member 21 is located on a side of the electrode terminal 13 facing away from the other end of the battery cell 10 in the first direction X, the supporting member 21 has a first cavity 201, and the first cavity 201 is configured to allow a first heat exchange medium to flow. In a same projection plane perpendicular to the first direction, an orthographic projection of the electrode terminal 13 and an orthographic projection of the first cavity 201 are spaced apart.

There may be one or a plurality of electrode terminals 13 arranged, and the battery cell 10 is provided with the electrode terminal 13 only at one end in the first direction X. For example, as shown in FIG. 3, the first direction X may be a height direction of the battery cell 10, and the electrode terminal 13 may be arranged on the end cover 111, or the electrode terminal 13 may be arranged on a wall of the case 112 in the first direction X facing away from the end cover 111.

The position-limiting assembly 20 is configured to limit a position of the battery cell 10 to fix its position. The position-limiting assembly 20 includes a supporting member 21, the supporting member 21 is arranged in the first direction X toward the electrode terminal 13 of the battery cell 10, and the supporting member 21 has a first cavity 201 allowing a first heat exchange medium to flow, so that the supporting member 21 has a function of thermal management of the battery cell 10. By arranging the first cavity 201 allowing the first heat exchange medium to flow to be closer to the electrode terminal 13, the first heat exchange medium can directly cool a heat concentrated area in the battery cell 10, so as to reduce the temperature near the electrode terminal 13 and reduce the occurrence of rapid heat diffusion to surrounding regions, which is conducive to improving the cooling effect of the battery cell 10, and can also reduce the possibility of local overtemperature, so that the temperature distribution of the battery cell 10 is uniform, which is conducive to improving the performance of the battery cell 10, and further conducive to improving the performance of the battery apparatus 1.

“In the first direction X, the supporting member 21 is located on the side of the electrode terminal 13 facing away from the other end of the battery cell 10 in the first direction X” can be understood as that the battery cell 10 has a first end and a second end oppositely arranged in the first direction X, the electrode terminal 13 is arranged at the first end, and in the first direction X, the supporting member 21 is arranged on the side of the electrode terminal 13 facing away from the second end.

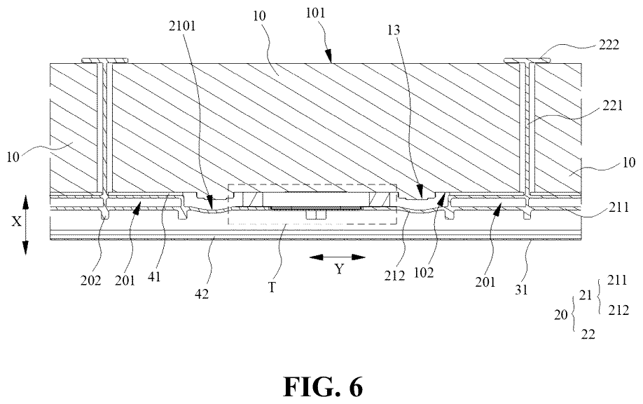

As shown in FIG. 6, “in the same projection plane perpendicular to the first direction X, the orthographic projection of the electrode terminal 13 and the orthographic projection of the first cavity 201 are spaced apart” means that in the same projection plane perpendicular to the first direction X, the orthographic projection of the electrode terminal 13 and the orthographic projection of the first cavity 201 do not have any overlapping parts, and the electrode terminal 13 and the first cavity 201 are completely staggered. That is to say, the first cavity 201 may be located on the side of the electrode terminal 13 to exchange heat with the battery cell 10. The above arrangement is capable of reducing the possibility of interference between the first cavity 201 and the electrode terminal 13, thereby being capable of reducing the possibility of the first heat exchange medium in the first cavity 201 contacting with the electrode terminal 13 and causing safety problems such as an electrical connection, which is conducive to improving the reliability of the battery apparatus 1. In addition, the above arrangement is further capable of reducing an overall size of the battery apparatus 1 in the first direction X, which is conducive to improving a space utilization of the battery apparatus 1, or is further capable of increasing a size of the battery cell 10 in the first direction X to improve the energy density of the battery cell 10.

Therefore, in the battery apparatus 1 according to some embodiments of the present application, by arranging the supporting member 21 on the side of the battery cell 10 facing the electrode terminal 13, the supporting member 21 is capable of directly cooling the heat in a region near the electrode terminal 13, so as to reduce the possibility of heat diffusion to the surrounding region, and to be capable of better improving the cooling effect and uniformity of the battery cell 10, thereby being conducive to improving the performance of the battery cell 10, and further improving the performance of the battery apparatus 1. In addition, by staggering the electrode terminal 13 and the first cavity 201, the possibility of interference between the two is capable of being effectively reduced, thereby reducing the possibility of a safety problem such as electrical connection, and being conducive to improving the reliability of the battery apparatus 1.

The first heat exchange medium is capable of flowing in the first cavity 201 to exchange heat with the battery cell 10. The first heat exchange medium may have various forms. For example, the first heat exchange medium may include water, air, a phase change material, or the like.

Optionally, the first cavity 201 may be configured as a linear structure, or the first cavity 201 may be configured as a curved structure, where the curved structure includes an arc structure and a bent structure.

Optionally, the supporting member 21 may be made of a high thermal conductivity material, such as an aluminum alloy or a composite material, which has sufficient strength and is capable of improving the heat exchange efficiency between the first heat exchange medium and the battery cell 10 and reducing the contact resistance.

Optionally, the electrode terminal 13 may be located at the bottom of the battery cell 10 in the first direction X, that is, at the bottom of the entire battery apparatus 1, so that the supporting member 21 is also located at the bottom of the entire battery apparatus 1, and the battery cell 10 may be supported by the supporting member 21. Alternatively, the electrode terminal 13 may also be located at the top of the battery cell 10 in the first direction X, that is, located at the top of the entire battery apparatus 1, so that the supporting member 21 is also located at a top side of the entire battery apparatus 1.

Optionally, the battery cell 10 can be connected to the part of the supporting member 21 provided with the first cavity 201, so that the supporting member 21 can not only be used to limit the displacement of the battery cell 10 in the first direction X toward the side where the supporting member 21 is located, but also can be connected to the battery cell 10 more closely and compactly, which is conducive to improving the thermal management efficiency of the battery cell 10 and also conducive to improving the structural compactness of the battery apparatus 1.

In some embodiments, in order to reduce the occurrence of electrical connection problems, in the first direction X, the electrode terminal 13 is spaced apart from the supporting member 21, and in a direction perpendicular to the first direction X, the electrode terminal 13 is spaced apart from the supporting member 21, that is, the side of the electrode terminal 13 facing away from the battery cell 10 and the peripheral side thereof have a gap from the supporting member 21 to reduce the possibility of contact between the electrode terminal 13 and the supporting member 21, so as to improve the reliability of the battery apparatus 1.

For example, in a second direction Y, the electrode terminal 13 is spaced apart from the supporting member 21, and in a third direction Z, the electrode terminal 13 is spaced apart from the supporting member 21. The first direction X may be the height direction of the battery cell 10 or the battery apparatus 1, the second direction Y is a length direction of the battery cell 10 or the battery apparatus 1, and the third direction Z is a width direction of the battery cell 10 or the battery apparatus 1; or, the second direction Y is a width direction of the battery cell 10 or the battery apparatus 1, and the third direction Z is a length direction of the battery cell 10 or the battery apparatus 1.

Optionally, there may be one supporting member 21, and the one supporting member 21 includes a plurality of first cavities 201. Alternatively, there may be a plurality of supporting members 21, the plurality of supporting members 21 are arranged in the second direction Y and connected to form a whole, and each of the supporting members 21 may include one or a plurality of first cavities 201.

Referring to FIG. 6, in some embodiments, in the same projection plane perpendicular to the second direction Y, an orthographic projection of the electrode terminal 13 overlaps with an orthographic projection of the first cavity 201.

“In the same projection plane perpendicular to the second direction Y, the orthographic projection of the electrode terminal 13 overlaps with the orthographic projection of the first cavity 201” means that in the same projection plane perpendicular to the second direction Y, the orthographic projection of the electrode terminal 13 and the orthographic projection of the first cavity 201 at least partially overlap in a region. In the embodiment of the present application, “overlap” may be understood as the two having a partial overlapping region, or the two completely overlapping.

The above arrangement is capable of making the first cavity 201 to be closer to the electrode terminal 13, and can better exchange heat with the electrode terminal 13, which is conducive to reducing the possibility of heat concentration at the electrode terminal 13, and further reducing the rate at which the heat at the electrode terminal 13 diffuses to the surrounding region. Furthermore, the battery cell 10 and the supporting member 21 are capable of being arranged more compactly, thereby improving the space utilization of the battery apparatus 1.

As shown in FIG. 3, in some embodiments, the battery cell 10 further includes a pressure relief mechanism 14, and the pressure relief mechanism 14 is configured to relieve an emission within the battery cell 10.

Optionally, the pressure relief mechanism 14 and the electrode terminal 13 may be arranged at the same end of the battery cell 10 in the first direction X, or the pressure relief mechanism 14 may also be arranged at one end of the battery cell 10 in the first direction X facing away from the electrode terminal 13 to protect the electrode terminal 13 from impact during thermal runaway.

Optionally, the supporting member 21 may be arranged in the box body 30, or the supporting member 21 may also be used as a part of the box body 30. Optionally, the supporting member 21 and the box body 30 may be an integrally formed structure, or the supporting member 21 and the box body 30 may be separately arranged and connected to each other.

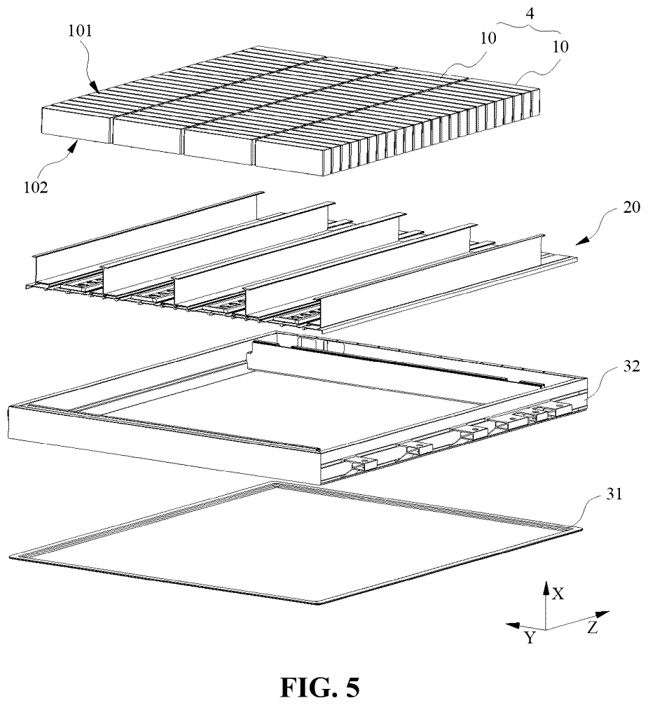

Referring to FIG. 5 and FIG. 6, in some embodiments, the first direction X is the height direction of the battery cell 10. In the first direction X, the battery cell 10 has a top end 101 and a bottom end 102 that are oppositely arranged. The electrode terminal 13 is arranged at the bottom end 102 of the battery cell 10, and the battery cell 10 is supported by the supporting member 21.

In the first direction X, a height position of the top end 101 is higher than a height position of the bottom end 102.

By arranging the electrode terminal 13 at the bottom end 102 of the battery cell 10, and the supporting member 21 having the first cavity 201 is also located at the bottom end 102 of the battery cell 10, the supporting member 21 can provide thermal management for the battery cell 10 as well as support and protection functions, which is conducive to better improving the performance and reliability of the battery apparatus 1.

Furthermore, through the above arrangement, the heat of the battery cell 10 near the electrode terminal 13 may be quickly discharged through the supporting member 21 located at the bottom end 102, which is also conducive to reducing the risk of thermal runaway.

As shown in FIG. 3, the top end 101 of the battery cell 10 may be an end of the end cover 111 in the first direction X facing away from the case 112, and correspondingly, the bottom end 102 of the battery cell 10 is an end of the case 112 in the first direction X facing away from the end cover 111. Alternatively, the top end 101 of the battery cell 10 may be an end of the case 112 in the first direction X facing away from the end cover 111, and correspondingly, the bottom end 102 of the battery cell 10 is an end of the end cover 111 in the first direction X facing away from the case 112.

Specifically, the battery cell 10 is supported on the supporting member 21 through the shell 11, and the supporting member 21 is capable of providing support and protection functions thereto to reduce the risk of cracking of the shell 11.

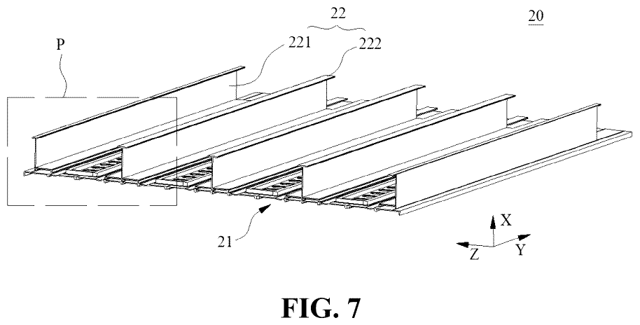

Referring to FIG. 6 to FIG. 9, in some embodiments, the supporting member 21 includes a first supporting portion 211 and a second supporting portion 212 interconnected in the second direction Y, the first supporting portion 211 has a first cavity 201, and in the first direction X, the battery cell 10 and the second supporting portion 212 are spaced apart, and a side surface of the first supporting portion 211 facing the battery cell 10 protrudes from a side surface of the second supporting portion 212 facing the battery cell 10, and the first direction X intersects with the second direction Y.

The first supporting portion 211 has the first cavity 201. For example, the first supporting portion 211 is connected to the battery cell 10 so that the battery cell 10 can be closer to the first cavity 201, which is conducive to improving the thermal management efficiency of the first supporting portion 211 on the battery cell 10. Furthermore, the battery cell 10 can be connected to the first supporting portion 211 more compactly and tightly, which is conducive to improving the connection strength between the battery cell 10 and the supporting member 21, so as to enhance the position-limiting effect on the battery cell 10.

The second supporting portion 212 and the battery cell 10 are spaced apart in the first direction X to reduce the possibility of interference between the second supporting portion 212 and the electrode terminal 13. In addition, the gap between the second supporting portion 212 and the battery cell 10 in the first direction X can also absorb mechanical impact from the outside to improve the protection for the battery cell 10, thereby facilitating the improvement of the reliability and service life of the battery apparatus 1.

The first supporting portion 211 and the second supporting portion 212 are connected and arranged in the second direction Y, where the electrode terminal 13 and the second supporting portion 212 are arranged oppositely in the first direction X. The battery cell 10 and the second supporting portion 212 are spaced apart, and the gap therebetween is further capable of reserving an accommodation space for the electrode terminal 13 to reduce the occurrence of electrical connection problems between the electrode terminal 13 and the second supporting portion 212, thereby improving the reliability of the battery apparatus 1. For example, in the first direction X, the electrode terminal 13 is spaced apart from the second supporting portion 212.

The first supporting portion 211 faces one side surface of the battery cell 10 and protrudes from the side surface of the second supporting portion 212 facing the battery cell 10. The above arrangement causes the first supporting portion 211 to be closer to the battery cell 10 relative to the second supporting portion 212, which is conducive to improving the thermal management efficiency of the battery cell 10, thereby better improving the performance of the battery cell 10 and the battery apparatus 1. Furthermore, the supporting member 21 may be provided with a stepped structure, which is capable of saving materials and reducing occupied space while achieving thermal management and protection functions of the battery cell 10.

Optionally, the second supporting portion 212 may be configured as a single-layer plate structure, and the first supporting portion 211 may be configured as a double-layer plate structure having the first cavity 201, which is conducive to reducing cost and weight.

Optionally, the first supporting portion 211 and the second supporting portion 212 may be an integrally extruded structure, or the first supporting portion 211 and the second supporting portion 212 may be provided separately and then assembled.

Optionally, in the same projection plane perpendicular to the first direction X, the orthographic projection of the electrode terminal 13 and the orthographic projection of the first supporting portion 211 may be spaced apart, or the orthographic projection of the electrode terminal 13 and the orthographic projection of the first supporting portion 211 may also have an overlapping portion. Under this structure, in the first direction X, the electrode terminal 13 and the first supporting portion 211 are spaced apart, and in the same projection plane perpendicular to the first direction X, the orthographic projection of the electrode terminal 13 and the orthographic projection of the first cavity 201 are spaced apart.

Referring to FIG. 6, in some embodiments, in the same projection plane perpendicular to the first direction X, the orthographic projection of the electrode terminal 13 and the orthographic projection of the first supporting portion 211 are spaced apart.

That is to say, the electrode terminal 13 and the first supporting portion 211 are completely staggered. The above arrangement is conducive to reducing the possibility of interference between the electrode terminal 13 and the first supporting portion 211, thereby improving the reliability of the battery apparatus 1.

In some embodiments, in the same projection plane perpendicular to the second direction Y, the orthographic projection of the electrode terminal 13 overlaps with the orthographic projection of the first supporting portion 211.

The above arrangement is capable of making the first supporting portion 211 having the first cavity 201 to be closer to the electrode terminal 13, so as to perform heat exchange with the electrode terminal 13 more quickly, which is conducive to reducing the possibility of heat concentration at the electrode terminal 13, and further reducing the rate at which the heat at the electrode terminal 13 diffuses to the surrounding region. Furthermore, the battery cell 10 and the supporting member 21 are capable of being arranged more compactly, thereby improving the space utilization of the battery apparatus 1.

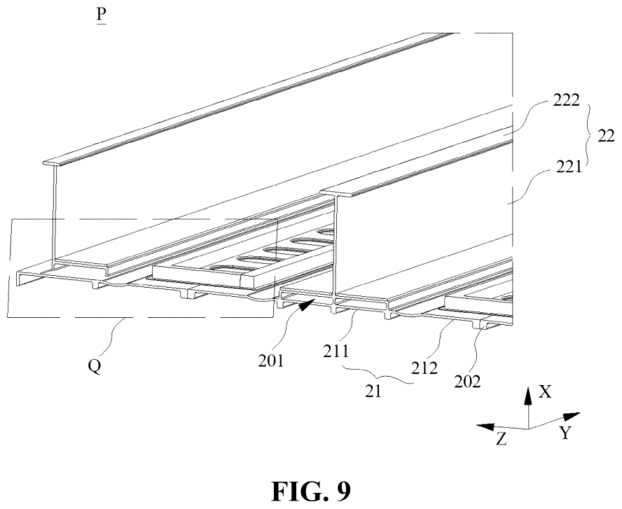

Referring to FIG. 6 and FIG. 9, in some embodiments, the battery apparatus 1 further includes a first heat-conducting structure 41, the first heat-conducting structure 41 is arranged between the first supporting portion 211 and the battery cell 10, and the battery cell 10 is connected to the first supporting portion 211 through the first heat-conducting structure 41.

The battery cell 10 may be bonded and connected to the first supporting portion 211 through the first heat-conducting structure 41, or the battery cell 10 may be abutted and connected to the first supporting portion 211 through the first heat-conducting structure 41.

The first heat-conducting structure 41 is configured to improve the heat conductivity between the first supporting portion 211 and the battery cell 10, thereby being conducive to improving the cooling effect of the first supporting portion 211 on the battery cell 10, so that the temperature of the battery cell 10 is maintained within a suitable temperature range, thereby improving the performance of the battery cell 10, and further improving the performance of the battery apparatus 1.

Furthermore, by arranging the first heat-conducting structure 41 between the battery cell 10 and the first supporting portion 211, the risk of contact collision between the battery cell 10 and the first supporting portion 211 may be reduced, thereby improving the safety of the battery cell 10 and thus being conducive to improving the reliability and service life of the battery apparatus 1.

The battery apparatus 1 according to some embodiments of the present application, by arranging the first heat-conducting structure 41, is conducive to improving the heat exchange efficiency between the first supporting portion 211 and the battery cell 10, and is further conducive to improving the connection strength between the two, and can also effectively reduce the possibility of collision between the two.

Optionally, the first heat-conducting structure 41 includes a heat-conducting adhesive, and the heat-conducting adhesive may be arranged on at least one of the battery cell 10 and the first supporting portion 211 by a process such as immersion or coating.

The heat-conducting adhesive can not only effectively conduct the heat of the first supporting portion 211, but also play a role in bonding and fixing, so that the battery cell 10 and the first supporting portion 211 maintain a stable connection in an environment of vibration or temperature change. The heat-conducting adhesive can also reduce thermal resistance, which helps to reduce the resistance in a heat conduction path from the first supporting portion 211 to the battery cell 10, thereby improving the heat exchange efficiency.

Optionally, the first heat-conducting structure 41 may include but is not limited to any one of heat-conducting silicone grease, epoxy resin adhesive, and two-component polyurethane heat-conducting adhesive.

As shown in FIG. 9, in some embodiments, there are a plurality of supporting members 21, the plurality of supporting members 21 are welded in sequence in the second direction Y, and the first supporting portion 211 and the second supporting portion 212 in each of the supporting members 21 are an integrated structure.

By setting that there are a plurality of supporting members 21 and the plurality of supporting members 21 are welded in sequence in the second direction Y to form an integrated body, it is convenient to process and manufacture the supporting members 21, which is conducive to reducing the difficulty of processing and improving the flexibility of use. The number of supporting members 21 may be set according to the size of the battery apparatus 1, and the plurality of supporting members 21 are connected as an integrated body by welding, which is conducive to improving the structural strength of the plurality of supporting members 21 after being connected, thereby being conducive to improving the thermal management effect and protective effect of the supporting members 21 on the battery cell 10, and further being conducive to improving the service life and reliability of the battery apparatus 1. In addition, it is also conducive to improving the sealing performance between the plurality of supporting members 21, thereby being conducive to improving the protection effect of the battery cell 10.

Optionally, two adjacent supporting members 21 may be welded via their respective second supporting portions 212, which is capable of reducing the impact of welding on the first cavity 201 and improving the reliability of the supporting members 21.

Optionally, the welding method between two adjacent supporting members 21 may be friction stir welding.

The first supporting portion 211 and the second supporting portion 212 in each of the supporting members 21 may be an integrally extruded structure with a compact layout, which is conducive to improving space utilization and further improving the connection strength between the two, thereby improving the structural strength of the supporting member 21 and thus improving the reliability of the battery apparatus 1.

Referring to FIG. 6 and FIG. 9, in some embodiments, in the first direction X, a groove 2101 is provided on a side of the second supporting portion 212 facing the battery cell 10, and the orthographic projection of the electrode terminal 13 falls into the groove 2101.

“The orthographic projection of the electrode terminal 13 falls into the groove 2101” means that, in the same projection plane perpendicular to the first direction X, an orthographic projection of the groove 2101 covers the orthographic projection of the electrode terminal 13.

By arranging the electrode terminal 13 and the groove 2101 relative to each other in the first direction X, the electrode terminal 13 and the second supporting portion 212 are spaced farther apart, thereby reducing the risk of electrical connection problems caused by contact between the electrode terminal 13 and the second supporting portion 212 when the battery cell 10 expands and deforms or the second supporting portion 212 is deformed by external vibration, which is conducive to further improving the reliability of the battery apparatus 1.

When the electrode terminal 13 is located at the bottom end 102 of the battery cell 10, the temperature change caused by the first supporting portion 211 in the process of thermal management for the battery cell 10 will cause a temperature difference with the surrounding environment, which may easily generate condensation water on the surface of the first supporting portion 211. The condensation water may follow the trend to flow downward to the second supporting portion 212. Therefore, by providing the groove 2101 on the side of the second supporting portion 212 facing the electrode terminal 13, the condensation water can follow the trend to flow downward into the groove 2101, thereby reducing the possibility of safety problems caused by contact between the electrode terminal 13 and the condensation water.

Optionally, it may be set that there is one groove 2101, and in the first direction X, orthographic projections of the electrode terminals 13 of all the battery cells 10 fall into the same groove 2101.

Optionally, the quantity of the grooves 2101 may be set to be a plurality, and one groove 2101 may be set corresponding to one electrode terminal 13, or one groove 2101 can also be set corresponding to a plurality of electrode terminals 13. For example, the grooves 2101 are distributed at intervals, and the grooves 2101 are arranged in one-to-one correspondence with the electrode terminals 13.

Optionally, the grooves 2101 may extend in the third direction Z.

For example, the shape of the groove 2101 may be set to be an arc-shaped groove, which is conducive to reducing the stress concentration caused by forming the groove 2101 on the second supporting portion 212, so that the second supporting portion 212 has sufficient strength.

As shown in FIG. 9, in some embodiments, in the first direction X, the second supporting portion 212 has a first surface 2121 and a second surface 2122 that are oppositely arranged, the first surface 2121 is arranged facing the battery cell 10, the groove 2101 is recessed from the first surface 2121 toward the second surface 2122, and a protruding portion 2102 protruding from the second surface 2122 is formed at a position of the second supporting portion 212 corresponding to the groove 2101.

In the process of forming the groove 2101 on the second supporting portion 212, a protruding portion 2102 opposite to the groove 2101 is also formed in the first direction X, so that the thickness of each position of the second supporting portion 212 tends to be consistent, which is conducive to reducing costs and also conducive to improving the strength of the second supporting portion 212 at the position where the groove 2101 is provided, so as to improve the reliability of the battery apparatus 1.

In some embodiments, the second supporting portion 212 has a via hole in communication with the groove 2101.

The via hole is capable of absorbing a deformation stress of the second supporting portion 212 at the groove 2101 to absorb the deformation caused by vibration or impact, thereby reducing the risk of breakage of the second supporting portion 212 and improving the structural strength of the second supporting portion 212, and further improving the reliability of the battery apparatus 1.

When the electrode terminal 13 is located at the bottom end 102 of the battery cell 10, condensation water generated on the surface of the first supporting portion 211 is capable of being collected in the groove 2101 and flow out through the via hole, which is conducive to better reducing the possibility of the electrode terminal 13 contacting with the condensation water.

Optionally, the via hole passes through the second supporting portion 212 in the first direction X.

In some embodiments, in the same projection plane perpendicular to the first direction X, the orthographic projection of the electrode terminal 13 overlaps with an orthographic projection of the via hole.

There may be a plurality of via holes, and optionally, the via holes are in one-to-one correspondence with the electrode terminals 13; or, one electrode terminal 13 may be corresponding to a plurality of via holes, and in the first direction X, the orthographic projection of the electrode terminal 13 overlaps with the orthographic projection of at least one via hole.

The above arrangement is capable of better reducing the risk of the electrode terminal 13 contacting with the condensation water, thereby further improving the reliability and service life of the battery apparatus 1.

Referring to FIG. 4 to FIG. 6, in some embodiments, the battery apparatus 1 further includes a box body 30, and the battery cell 10 and the supporting member 21 are both arranged in the box body 30. The box body 30 includes a bottom plate 31. In the first direction X, the bottom plate 31 is arranged on a side of the supporting member 21 facing away from the battery cell 10, and there is a gap between the via hole and the bottom plate 31.

The box body 30 has an accommodating cavity, and the battery cell 10 and the supporting member 21 are both arranged in the accommodating cavity. The box body 30 is capable of protecting the battery cell 10 and the supporting member 21 to improve the reliability of the battery apparatus 1.

The bottom plate 31 is arranged on one side of the accommodating cavity in the first direction X. When the electrode terminal 13 is located at the bottom end 102 of the battery cell 10, the bottom plate 31 is located at the bottom of the box body 30. By arranging the via hole and the bottom plate 31 to be spaced apart in the first direction X, the condensation water flowing out of the via hole is capable of flowing between the bottom plate 31 and the supporting member 21, which can reduce the possibility of the condensation water flowing out of the box body 30, thereby reducing the possibility of interference with the external environment.

Referring to FIG. 6, in some embodiments, the battery apparatus 1 further includes a drying assembly 42. In the first direction X, the drying assembly 42 is arranged between the second supporting portion 212 and the bottom plate 31, and the orthographic projection of the via hole falls in the drying assembly 42.

The drying assembly 42 is capable of absorbing moisture generated in the heat exchange process through the via hole, to prevent excessive moisture from condensing into water droplets, thereby reducing the possibility of water accumulation in the box body 30 causing poor insulation withstand voltage and the risk of thermal runaway, thereby being conducive to improving the safety performance of the battery cells 10 in the box body 30.

The drying assembly 42 may be a substance with a drying function, which may be a chemical desiccant, such as calcium sulfate and calcium chloride, which performs drying by combining with moisture to form hydrates, or a physical desiccant, such as silica gel and activated alumina, which performs drying by physically adsorbing moisture.

The drying assembly 42 may also be a structural body packaged with drying substances, and the structural body is capable of being in communication with the battery cell 10 through the via hole, so that the drying substances in the structure absorb the moisture.

When the electrode terminal 13 is located at the bottom end 102 of the battery cell 10, the drying assembly 42 can further be configured to absorb condensation water flowing out of the via hole to reduce the possibility of water accumulation in the box body 30 causing poor insulation withstand voltage and the risk of thermal runaway, which is conducive to maintaining a dry environment in the box body 30 and improving the reliability of the battery apparatus 1.

The drying assembly 42 may also be a water-absorbing structure such as a sponge or foam.

The drying assembly 42 and at least one of the second supporting portion 212 and the bottom plate 31 may be arranged as structured that are detachably connected, or may be connected in a method such as welding or bonding.

Still referring to FIG. 6, in some embodiments, the box body 30 further includes a frame 32, the frame 32 is welded to the supporting member 21 and they enclose to form an accommodating space, and the battery cell 10 is accommodated in the accommodating space.

The frame 32 is arranged around a peripheral side of the accommodating cavity of the box body 30.

By welding the supporting member 21 and the frame 32, it is conducive to improving the connection strength between the supporting member 21 and the frame 32, so as to reduce the possibility of risks such as displacement of the supporting member 21, which is conducive to improving the reliability of the battery apparatus 1, and it is further conducive to improving the sealing performance between the supporting member 21 and the frame 32, and further conducive to improving the protection effect for the battery cell 10 located in the accommodating space.

Optionally, the frame 32 is welded to the second supporting portion 212, which is capable of reducing the impact of welding on the first cavity 201, so as to improve the reliability of the supporting member 21, thereby being conducive to improving the reliability of the battery apparatus 1.

Optionally, the welding method between the frame 32 and the supporting member 21 may be friction stir welding.

Optionally, the bottom plate 31 may be connected to the supporting member 21, or the bottom plate 31 may also be connected to the frame 32.

In some embodiments, the bottom plate 31 is connected to the frame 32.

The above arrangement facilitates assembling and has a reasonable layout. When the bottom plate 31 is subjected to external vibration or impact, the force transmitted to the supporting member 21 can be reduced or even eliminated, which is conducive to improving the reliability and service life of the supporting member 21, thereby improving the thermal management effect of the supporting member 21 on the battery cell 10, and further conducive to improving the performance of the battery apparatus 1.

In some embodiments, in the first direction X, there is a gap between the supporting member 21 and the bottom plate 31.

This arrangement is capable of better reducing the possibility of the force applied to the bottom plate 31 being transmitted to the supporting member 21, thereby improving the protective effect of the bottom plate 31 on the supporting member 21, which is conducive to improving the reliability and service life of the supporting member 21, thereby improving the thermal management effect of the supporting member 21 on the battery cell 10, and further conducive to improving the performance of the battery apparatus 1.

Optionally, the bottom plate 31 is connected to the frame 32, and in the first direction X, there is a gap between the supporting member 21 and the bottom plate 31.

Optionally, the connection method between the bottom plate 31 and the frame 32 may be, but is not limited to, a rivet nut and a bolt lock connection.

Optionally, the supporting member 21 is connected to an inner side surface of the frame 32 in the second direction Y through the second supporting portion 212, and the bottom plate 31 is connected to one side of the frame 32 in the first direction X.

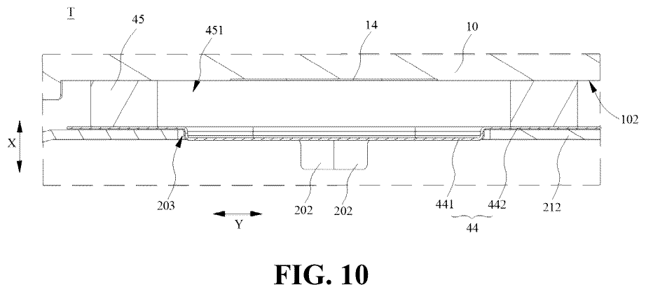

Referring to FIG. 3, FIG. 6, and FIG. 10, in some embodiments, the battery cell 10 further includes a pressure relief mechanism 14. In the first direction X, the pressure relief mechanism 14 is arranged at one end of the battery cell 10 facing the electrode terminal 13. The pressure relief mechanism 14 is configured to discharge an emission in the battery cell 10. In the same projection plane perpendicular to the first direction, an orthographic projection of the pressure relief mechanism 14 the an orthographic projection of the first cavity 201 are spaced apart.

As an example, when the internal pressure or temperature of the battery cell 10 reaches a predetermined threshold, actuation is done to relieve the internal pressure or temperature. When the internal pressure or temperature of the battery cell 10 reaches a predetermined threshold, the pressure relief mechanism 14 executes an action or a weak structure provided in the pressure relief mechanism 14 is damaged, so as to form an opening or channel for relieving the internal pressure or temperature, so as to discharge the emission. The preset threshold varies according to different design requirements. The threshold may depend on the material of one or more of a positive electrode plate, a negative electrode plate, an electrolyte, and a separator in the battery cell 10.

When a battery cell 10 experiences thermal runaway, its pressure relief mechanism 14 is actuated to discharge an emission. By completely staggering the pressure relief mechanism 14 with the first cavity 201, the emission discharged by the pressure relief mechanism 14 will not directly act on the first cavity 201, thereby reducing the possibility of damage to the first cavity 201 or even leakage, thereby minimizing the impact of thermal runaway of a battery cell 10 and reducing the possibility of a series of chain problems such as electrical connection of the battery cell 10.

The emission from the battery cell 10 mentioned in the present application includes, but is not limited to, the electrolyte solution, dissolved or split positive and negative electrode plates, fragments of the separator, high-temperature and high-pressure gas generated by reaction, flames, and the like.

Optionally, in the same projection plane perpendicular to the first direction X, an orthographic projection of the pressure relief mechanism 14 and the orthographic projection of the first supporting portion 211 are spaced apart.

Optionally, in the same projection plane perpendicular to the first direction X, the orthographic projection of the pressure relief mechanism 14 falls in the orthographic projection of the second supporting portion 212.

Optionally, in the first direction X, the pressure relief mechanism 14 and the second supporting portion 212 are spaced apart.

For example, the pressure relief mechanism 14 is arranged on the shell 11, and the pressure relief mechanism 14 is configured to discharge internal gas and the emission of the battery cell 10.

Optionally, the electrode terminal 13 and the pressure relief mechanism 14 are both arranged at the bottom end 102 of the battery cell 10 in the first direction X.

The above arrangement causes the pressure relief mechanism 14 to be arranged downward in the battery apparatus 1, and when the battery cell 10 has thermal runaway, its high-temperature and high-pressure gas and emission are capable of being discharged through the bottom of the battery apparatus 1. When the battery apparatus 1 is applied to an electrical device such as a vehicle, the high-temperature and high-pressure gas and emission are discharged to the outside of the vehicle through the bottom of the vehicle, which is capable of reducing or even eliminating the safety risks to people on the vehicle.

Furthermore, since the first supporting portion 211 provided with the first cavity 201 is also arranged at the bottom end 102 of the battery cell 10, when a battery cell 10 experiences thermal runaway and discharges an emission downward, since the pressure relief mechanism 14 is close to the first supporting portion 211, the first supporting portion 211 is further capable of playing a role in delaying the diffusion speed of the thermal runaway to the surroundings, thereby reducing the possibility of thermal runaway occurring in other battery cells 10, which is conducive to reducing the chain reaction caused by the failure of a battery cell 10.

As an example, the pressure relief mechanism 14 may be integrally formed with the shell 11.

As an example, the pressure relief mechanism 14 may also be arranged separately from and connected to the shell 11.

In some embodiments, when the shell 11 is a non-sealed structure, the pressure relief mechanism 14 may be configured as a through hole for discharging the emission inside the battery cell 10.

For example, as shown in FIG. 6, in the second direction Y, the electrode terminal 13, the pressure relief mechanism 14, and the electrode terminal 13 are sequentially distributed on the battery cell 10, and the two electrode terminals 13 are each provided with a first supporting portion 211 having a first cavity 201 on the side facing away from each other, and the two electrode terminals 13 are each provided with a second supporting portion 212 on the side facing each other.

In some embodiments, the second supporting portion 212 is provided with a weak portion, and the weak portion and the pressure relief mechanism 14 are arranged oppositely in the first direction.

The weak portion on the second supporting portion 212 may be understood as that the strength of the second supporting portion 212 at the weak portion is less than its strength at other positions, so that under the impact of the emission, the weak portion may be quickly actuated, thereby being capable of reducing the risk of cracking of the second supporting portion 212 and improving the efficiency of emission discharge.

“The weak portion and the pressure relief mechanism 14 are arranged oppositely in the first direction X” may be understood as that, in the same projection plane perpendicular to the first direction X, an orthographic projection of the weak portion overlaps with the orthographic projection of the pressure relief mechanism 14, which is capable of reducing the discharge path of the emission, to reduce the occurrence of more serious safety problems due to the diffusion of the emission to other positions.

As an example, when the internal pressure or temperature of the battery cell 10 reaches a predetermined threshold, actuation is done to relieve the internal pressure or temperature. When the internal pressure or temperature of the battery cell 10 reaches a predetermined threshold, the pressure relief mechanism 14 executes an action or a weak structure arranged in the pressure relief mechanism 14 is damaged, so as to form an opening or channel for relieving the internal pressure or temperature. The emission discharged by the pressure relief mechanism 14 may impact the weak portion on the second supporting portion 212, so that the weak portion is damaged, and the emission is capable of being discharged from the weak portion on the second supporting portion 212.

The term “actuate” referred to in the present application refers to that the pressure relief mechanism 14 and the weak portion on the second supporting portion 212 conduct an action or are activated to a certain state, so that the internal pressure and temperature of the battery cell 10 can be relieved. The action produced by the pressure relief mechanism 14 may include, but is not limited to: a component in the pressure relief mechanism 14 moves to form an exhaust passage; at least a portion in the pressure relief mechanism 14 is ruptured, crushed, torn, opened, or the like. The action produced by the weak portion on the second supporting portion 212 may include, but is not limited to: the weak portion moves to form an exhaust passage; at least a portion in the weak portion is ruptured, crushed, torn, opened, or the like.

When the weak portions on the pressure relief mechanism 14 and the second supporting portion 212 are actuated, high-temperature and high-pressure substances inside the battery cell 10 are discharged as emissions outwards from the actuated portions. In this way, the pressure and temperature of the battery cell 10 may be relieved under controllable pressure or temperature, so as to reduce potential more serious accidents.

Optionally, there are a plurality of weak portions, each battery cell 10 may be provided with a pressure relief mechanism 14, and the second supporting member 21 may be provided with a weak portion at a position corresponding to each pressure relief mechanism 14. For example, the pressure relief mechanisms 14 and the weak portions may be arranged in one-to-one correspondence.

For example, the groove 2101 and the weak portion are spaced apart in the second direction Y.

Referring to FIG. 9, in some embodiments, the weak portion is a discharge hole 203 passing through the second supporting portion 212.

By setting the weak portion as a hole-shaped structure, it is easy to process and manufacture, which is conducive to simplifying the structure and further conducive to reducing the actuation time of the weak portion, reducing the resistance to the outflow of the emission, enabling the emission to be discharged in time, and reducing the possibility of explosion caused by internal pressure accumulation.

The discharge hole 203 and the pressure relief mechanism 14 of the battery cell 10 are arranged correspondingly in the first direction X, which is capable of reducing the flow path of the emission and avoiding the risk of secondary retention or splashing of the emission due to path bending.

Optionally, an edge of the discharge hole 203 adopts an arc-shaped transition to reduce stress concentration.

Optionally, the shape of the discharge hole 203 may include but is not limited to at least one of a circle, a polygon, an ellipse, and the like.

Referring to FIG. 9 and FIG. 10, in some embodiments, the battery apparatus 1 further includes a blocking member 44. The blocking member 44 is connected to a side of the second supporting portion 212 facing the battery cell 10 in the first direction X, and the blocking member 44 covers the discharge hole 203. The blocking member 44 is configured to be actuated by the emission discharged from the corresponding battery cell 10 toward the discharge hole 203, so as to open the discharge hole 203.

The blocking member 44 is configured such that: when the battery apparatus 1 is in a normal environment and each battery cell 10 is in normal use, each discharge hole 203 is blocked by the corresponding blocking member 44; when a battery cell 10 in the battery apparatus 1 has thermal runaway, and the temperature or pressure inside the thermally runaway battery cell 10 exceeds a corresponding threshold value, the pressure relief mechanism 14 of the thermally runaway battery cell 10 is actuated, and the emission flows to the corresponding blocking member 44 through the actuating portion of the pressure relief mechanism 14, the blocking member 44 is acted upon by the emission of the battery cell 10 to open the discharge hole 203, and the discharge holes 203 corresponding to other battery cells 10 that have not experienced thermal runaway remain blocked by the blocking members 44.

The blocking member 44 is configured to be actuated by the emission discharged from the corresponding battery cell 10 toward the discharge hole 203. It is understandable that the blocking member 44 may be actuated or activated to a certain state under the action of the emission, so that the discharge hole 203 has a flow gap, allowing the emission to flow out through the discharge hole 203. For example, the blocking member 44 moving under the action of the emission may be that some components of the blocking member 44 move to form a flow gap under the action of the emission; or, at least a part of the blocking member 44 is broken, shattered, or torn apart from the discharge hole 203 under the action of the emission, or, the blocking member 44 is completely separated from the discharge hole 203, so that a flow gap is formed in the discharge hole 203, or the like. For example, the blocking member 44 may open the discharge hole 203 under the effect of the temperature or pressure generated by the emission; and the blocking member 44 may also open the discharge hole 203 under the effect of corrosion of the emission.

The blocking member 44 serves as a dynamic sealing barrier for the discharge hole 203. When the internal pressure of the battery cell 10 does not exceed the standard, the discharge hole 203 is kept closed, which is conducive to reducing the possibility of electrolyte leakage or intrusion of external contaminants. When the internal pressure reaches a preset threshold, the emission impacts the blocking member 44, causing it to detach or rupture, thereby achieving precise pressure relief.

In the above technical solution, the blocking member 44 is capable of preventing leakage of electrolyte or intrusion of particles such as foreign impurities, so as to improve the reliability of the battery apparatus 1.

Optionally, one blocking member 44 may be arranged, and one blocking member 44 is configured to block all discharge ports.

Optionally, a plurality of blocking members 44 may be arranged, and each discharge port is provided with a corresponding blocking member 44. For example, the discharge ports and the blocking members 44 are arranged in one-to-one correspondence.

The blocking member 44 and the second supporting portion 212 may be connected in a variety of ways. For example, the two may be connected by laser welding, or may be bonded by an adhesive, or may be connected by fasteners.

Optionally, the blocking member 44 may be configured as an insulating structure such as a plastic plate, which is easily actuated by the impact of the emission, and is also capable of improving the insulation effect between the second supporting portion 212 and the battery cell 10.

As shown in FIG. 10, in some embodiments, the blocking member 44 includes a blocking portion 441 and a connecting portion 442, the connecting portion 442 is connected to the second supporting portion 212, the blocking portion 441 protrudes from the connecting portion 442 in the first direction X toward a side facing away from the battery cell 10, and the blocking portion 441 extends into the discharge hole 203.

The blocking portion 441 is configured to be embedded in the discharge hole 203. Optionally, the blocking portion 441 may be tightly fitted with an inner wall of the discharge hole 203, or a gap may exist between the blocking portion 441 and the inner wall of the discharge hole 203.

By setting the blocking member 44 as a stepped structure, the blocking portion 441 may be actuated more quickly under the impact of the emission to open the discharge hole 203, and the actuation of the blocking portion 441 can also reduce the impact on the connecting portion 442.

Referring to FIG. 9 and FIG. 10, in some embodiments, the battery apparatus 1 further includes a flexible assembly 45, the flexible assembly 45 is arranged between the battery cell 10 and the second supporting portion 212 and encloses, together with the battery cell 10 and the second supporting portion 212, a discharge channel 451, and the pressure relief mechanism 14 is in communication with the weak portion through the discharge channel 451.

The bottom end 102 of the battery cell 10, the flexible assembly 45, and the second supporting portion 212 cooperate to define the discharge channel 451, which is conducive to the high-temperature gas and other emissions flowing from the discharge channel 451 to the weak portion and being discharged from the weak portion, thereby reducing the risk of the emissions spreading to the surrounding area.

When a battery cell 10 experiences thermal runaway, the pressure relief mechanism 14 of the battery cell 10 experiencing thermal runaway is actuated, and an emission therein flows to the discharge channel 451 through the actuated portion of the pressure relief mechanism 14, and then flows to the blocking member 44 through the discharge channel 451. The blocking member 44 opens the discharge hole 203 under the action of the emission, and the emission can flow out through the discharge hole 203 to release the pressure and discharge the emission of the battery cell 10 experiencing thermal runaway. The discharge holes 203 corresponding to the battery cells 10 that have not experienced thermal runaway remain blocked by the blocking member 44, and the blocking member 44 implements isolation protection between the battery cells 10, blocks the flow path of the emission of the thermal runaway from flowing to the battery cells 10 that have not experienced thermal runaway, reduces the possibility of the emission in the discharge channel 451 flowing to the battery cells 10 that have not experienced thermal runaway, and plays a role in reducing heat diffusion between the battery cells 10.

Optionally, one discharge channel 451 may be provided, and in the first direction X, orthographic projections of the pressure relief mechanisms 14 in the plurality of battery cells 10 all fall into the discharge channel 451. Alternatively, a plurality of discharge channels 451 may be provided, and the discharge channels 451 and the pressure relief mechanism 14 are arranged in one-to-one correspondence.

Optionally, the flexible assembly 45 may be supported by a structure having elastic deformation capability, and can not only be arranged around the peripheral side of the discharge channel 451, but also play a buffering role between the battery cell 10 and the second supporting portion 212.

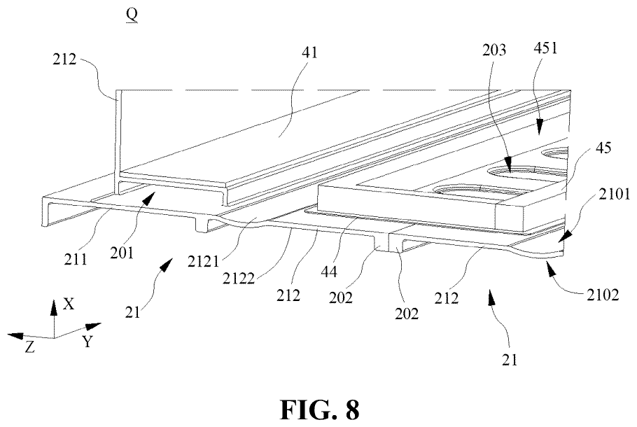

Referring to FIG. 6, FIG. 8, FIG. 9, and FIG. 10, in some embodiments, a reinforcement structure 202 is protruded from at least one side of the supporting member 21 in the first direction X.

The reinforcement structure 202 is configured to enhance the structural strength of the supporting member 21, thereby being conducive to improving the reliability of the battery apparatus 1.

Optionally, the reinforcement structure 202 may be connected to the first supporting portion 211, or may also be connected to the second supporting portion 212.

Optionally, the reinforcement structure 202 may be arranged on a side of the supporting member 21 in the first direction X facing the battery cell 10, or may also be arranged on a side of the supporting member 21 in the first direction X facing away from the battery cell 10.

For example, in the first direction X, the reinforcement structure 202 is protruded from a side of the second supporting portion 212 facing away from the battery cell 10. By arranging the reinforcement structure 202 facing away from the battery cell 10, the possibility of interference between the reinforcement structure 202 and the battery cell 10 is capable of being reduced.

The reinforcement structure 202 may be formed as an integrally formed structure with the supporting member 21, which is conducive to improving the processing efficiency and also conducive to improving the connection strength between the two, so as to enhance the structural strength of the supporting member 21. Alternatively, the reinforcement structure 202 may be provided separately from the supporting member 21 and then assembled, which is conducive to improving the flexibility of the quantity and layout of the reinforcement structure 202.

Optionally, one or, of course, a plurality of the reinforcement structures 202 may be arranged.

Referring to FIG. 9 and FIG. 10, in some embodiments, there are a plurality of supporting members 21, and the plurality of supporting members 21 are connected in sequence in the second direction Y. Each second supporting portion 212 is provided with a reinforcement structure 202 on at least one side in the second direction Y, and a reinforcement structure 202 is arranged at a connection between any two adjacent supporting members 21 among the plurality of supporting members 21.

It is understandable that among two adjacent supporting members 21, the second supporting portion 212 in at least one supporting member 21 is provided with a reinforcement structure 202 on the side facing away from the first supporting portion 211 in the second direction Y. When the two adjacent supporting members 21 are connected, the reinforcement structure 202 is provided at a connection position of the two.

The above arrangement allows the reinforcement structure 202 to increase the assembling area when the two adjacent supporting members 21 are connected, facilitates the connection and assembling of the two adjacent supporting members 21, and improves the connection strength of two adjacent supporting members 21, thereby being conducive to improving the reliability of the battery apparatus 1.

Referring to FIG. 5 to FIG. 10, in some embodiments, the position-limiting assembly 20 further includes a plurality of position-limiting members 22. In the first direction X, the plurality of position-limiting members 22 are connected to the side of the supporting member 21 facing the battery cell 10. The plurality of position-limiting members 22 are arranged in the second direction Y. The battery cell 10 is arranged between two adjacent position-limiting members 22 and fixed by the position-limiting members 22. The first direction X intersects with the second direction Y.

The position-limiting member 22 is capable of limiting the movement of the battery cell 10 in the second direction Y, which is convenient for mounting and positioning, and is further conducive to reducing the possibility of displacement of the battery cell 10.

The position-limiting member 22 and the supporting member 21 together define a space for accommodating the battery cell 10, which is convenient for installation, positioning, and position-limiting thereof, and is capable of better improving the reliability of the battery apparatus 1.

Optionally, the position-limiting member 22 and the supporting member 21 may be an integrally extruded structure, or the position-limiting member 22 and the supporting member 21 may be provided separately and then assembled.

For example, in the first direction X, the plurality of position-limiting members 22 are all connected to a side of the first supporting portion 211 facing the battery cell 10.

In some embodiments, the position-limiting member 22 has a second cavity, and the second cavity is configured to allow a second heat exchange medium to flow.

The position-limiting member 22 has the second cavity allowing the second heat exchange medium to flow, so that the position-limiting member 22 further has a function of performing thermal management on the battery cell 10. The position-limiting member 22 and the supporting member 21 jointly realize the thermal management for the battery cell 10, which is capable of better improving the performance of the battery cell 10 and further making the temperature distribution uniform, thereby being conducive to improving the performance of the battery cell 10, and further conducive to improving the performance of the battery apparatus 1.

Optionally, the second cavity may be configured as a linear structure, or the second cavity may be configured as a curved structure, where the curved structure includes an arc structure and a bent structure.

The second heat exchange medium is capable of flowing in the second cavity to exchange heat with the battery cell 10. The second heat exchange medium may have various forms. For example, the second heat exchange medium may include water, air, a phase change material, or the like.

In some embodiments, the position-limiting members 22 each include a first position-limiting portion 221 and a second position-limiting portion 222, the battery cell 10 is arranged between two adjacent first position-limiting portions 221, in the first direction X, the second position-limiting portion 222 is connected to a side of the first position-limiting portion 221 facing away from the supporting member 21, and at least one side of the second position-limiting portion 222 in the second direction Y protrudes from the first position-limiting portion 221.

For example, in the first direction X, the plurality of first position-limiting portions 221 are all connected to a side of the first supporting portion 211 facing the battery cell 10.

The above arrangement enables the second position-limiting portion 222 to cooperate with the first supporting portion 211 to limit the displacement of the battery cell 10 in the first direction X, and the plurality of first position-limiting portions 221 cooperate to limit the displacement of the battery cell 10 in the second direction Y, which is conducive to improving the safety of the battery cell 10 and thereby being conducive to improving the reliability of the battery apparatus 1.

Optionally, the position-limiting assembly 20 may be connected to the frame 32 through the second supporting portion 212, and/or the position-limiting assembly 20 may be connected to the frame 32 through the first position-limiting portion 221, and/or the position-limiting assembly 20 may be connected to the frame 32 through the second position-limiting portion 222.

In some embodiments, the box body 30 further includes a top plate, the top plate is connected to a side of the frame 32 in the first direction X facing away from the bottom plate 31, and the second position-limiting portion 222 is connected to the top plate.

Optionally, the first position-limiting portion 221 may have a second cavity, and two adjacent battery cells 10 may share one first position-limiting portion 221 capable of performing heat exchange, which has a compact layout, is conducive to simplifying the structure, and is further capable of reducing the impact on the energy density of the battery cells 10.

Optionally, the battery cell 10 includes first surfaces arranged in pairs and opposite to each other in the second direction Y, second surfaces arranged in pairs and opposite to each other in the first direction X, and third surfaces arranged in pairs and opposite to each other in the third direction Z. The area of the first surface is greater than the area of the second surface and also greater than the area of the third surface. The battery cell 10 contacts with the first position-limiting portion 221 through the first surface, which is conducive to providing heat exchange efficiency for the battery cell 10, thereby better improving the performance of the battery cell 10 and the battery apparatus 1.

Optionally, the first cavity 201 and the second cavity may be isolated from each other, that is, the first cavity 201 and the second cavity are independent cavities and there is no communicative part between the two. This arrangement allows the first heat exchange medium and the second heat exchange medium to be made of different materials, or further allows the temperature of the first heat exchange medium and the second heat exchange medium to be different. The specific setting may be made based on demands, which is conducive to improving the flexible use of the battery apparatus 1.

Optionally, the first cavity 201 and the second cavity may also be in communication with each other, and accordingly, the first heat exchange medium and the second heat exchange medium may be made of the same material, which is conducive to simplifying the structure and reducing the number of inlets and outlets for the first heat exchange medium or the second heat exchange medium to enter and exit.

Optionally, the second position-limiting portion 222 may also have a second cavity to perform heat management on a side of the battery cell 10 in the first direction X facing away from the supporting member 21.

Optionally, the second cavity includes a first sub-cavity arranged in the first position-limiting portion 221, and the second cavity further includes a second sub-cavity arranged in the second position-limiting portion 222. This arrangement is capable of better improving the efficiency of thermal management for the battery cell 10, so as to better improve the performance of the battery cell 10 and the battery apparatus 1.

Optionally, the first sub-cavity and the second sub-cavity may be isolated from each other, or may be in communication with each other.

Optionally, the first position-limiting portion 221 and the second position-limiting portion 222 may be an integrally extruded structure, or the first position-limiting portion 221 and the second position-limiting portion 222 may be provided separately and then assembled.

In some embodiments, in the first direction X, the second position-limiting portion 222 abuts against the end of the battery cell 10 facing away from the electrode terminal 13.

This arrangement is capable of further improving the position-limiting effect of the second position-limiting portion 222 on the battery cell 10, and further making the connection between the two tighter and more compact, which is conducive to reducing the occupied space and improving the space utilization of the battery apparatus 1.

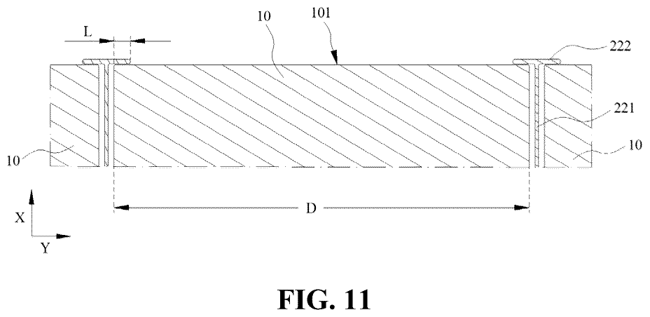

Referring to FIG. 11, in some embodiments, a size of the battery cell 10 in the second direction Y is D, and in the second direction Y, a size of a part of the second position-limiting portion 222 covering the battery cell 10 in the first direction X is L, where 1/100≤D/L≤1/5.

Optionally, the sizes of the second position-limiting portions 222 in the second direction Y may be the same, or may be different.

For example, a value of D/L may include but is not limited to 1/100, 2/50, 3/100, 1/10, 3/20, 1/5, and the like.

If the ratio of D/L is set too small, that is, D/L<1/100, the position-limiting effect of the second position-limiting portion 222 on the battery cell 10 in the first direction X will be reduced. If the ratio of D/L is set too large, that is, D/L>1/5, the material cost of the second position-limiting portion 222 will increase.

Therefore, by setting the ratio of D/L between 1/100 and 1/5, including the two end values 1/100 and 1/5, the cost of the battery apparatus 1 is capable of being reduced while the second position-limiting portion 222 provides a position-limiting effect on the battery cell 10.

In some embodiments, 3/200≤D/L≤3/20.

By further setting the ratio of D/L to be between 3/200 and 3/20, including the two end values 3/200 and 3/20, the position-limiting effect of the second position-limiting portion 222 on the battery cell 10 may be better improved.

In some embodiments, the first position-limiting portion 221 and the second position-limiting portion 222 are of an integrated structure.

The first position-limiting portion 221 and the second position-limiting portion 222 in each of the position-limiting members 22 may be an integrally extruded structure with a compact layout, which is conducive to improving space utilization and further improving the connection strength between the two, thereby being conducive to improving the reliability of the battery apparatus 1.

In some embodiments, the first position-limiting portion 221 and the supporting member 21 are of an integrated structure.

Specifically, the first position-limiting portion 221 and the first supporting portion 211 and the second supporting portion 212 in each of the supporting members 21 may be an integrally extruded structure with a compact layout, which is conducive to improving space utilization and further improving the connection strength between the three, thereby being conducive to improving the reliability of the battery apparatus 1.

In some embodiments, the first position-limiting portion 221, the second position-limiting portion 222, and the supporting member 21 are of an integrated structure.

For example, the first position-limiting portion 221, the second position-limiting portion 222, and the first supporting portion 211 and the second supporting portion 212 in each of the supporting members 21 may be an integrally extruded structure with a compact layout, which is conducive to improving space utilization and further improving the connection strength between the four to better fix the battery cell 10, thereby being conducive to improving the reliability of the battery apparatus 1.

Furthermore, the first position-limiting portion 221, the second position-limiting portion 222, and the first supporting portion 211 and the second supporting portion 212 of each of the supporting members 21 jointly fix the battery cell 10, thereby reducing the amount of adhesive applied and improving the position-limiting effect on the battery cell 10.

According to some embodiments of the present application, the present application further provides an electrical device including the battery apparatus 1 in any one of the above embodiments.

The battery apparatus 1 is configured to store or provide electrical energy.

The above illustrations are merely brief descriptions for the technical solutions of the present application. Specific implementation manners of the present application are described specifically in the following to understand the technical solutions of the present application more clearly and implement the present application according to content of the specification, and to make the above and other objectives, features and advantages of the present application more comprehensible.

Referring to FIG. 3 to FIG. 10 together, according to some embodiments of the present application, the present application provides a battery apparatus 1, including a battery cell 10, a position-limiting assembly 20, a first heat-conducting structure 41, a box body 30, a drying assembly 42, a blocking member 44, and a flexible assembly 45. A first direction X is a height direction of the battery cell 10, and a second direction Y intersects with the first direction X.

In the first direction X, the battery cell 10 has a top end 101 and a bottom end 102 that are oppositely arranged. The battery cell 10 and the position-limiting assembly 20 are both arranged in the box body 30. The battery cell 10 includes an electrode terminal 13 and a pressure relief mechanism 14. The electrode terminal 13 and the pressure relief mechanism 14 are both arranged at the bottom end 102 of the battery cell 10. The pressure relief mechanism 14 is configured to discharge an emission in the battery cell 10.

The position-limiting assembly 20 includes a plurality of supporting members 21 and a plurality of position-limiting members 22. In the first direction X, each of the supporting members 21 is located on the side of the electrode terminal 13 facing away from the top end 101 of the battery cell 10. Each of the supporting members 21 includes a first supporting portion 211 and a second supporting portion 212 connected to each other in the second direction Y. The supporting members 21 are connected as an integrated body by stir friction welding in the second direction Y through their own second supporting portions 212. The first supporting portion 211 has the first cavity 201, and the first cavity 201 is configured to allow the first heat exchange medium to flow. In the first direction X, a side surface of the first supporting portion 211 facing the battery cell 10 protrudes from a side surface of the second supporting portion 212 facing the battery cell 10. The battery cell 10 is connected to the first supporting portion 211 through the first heat-conducting structure 41 and is spaced apart from the second supporting portion 212.

The plurality of position-limiting members 22 are arranged in the second direction Y, and each of the position-limiting member 22 includes a first position-limiting portion 221 and a second position-limiting portion 222. In the second direction Y, the battery cell 10 is arranged between two adjacent first position-limiting portions 221. In the first direction X, the first position-limiting portion 221 is connected between the second position-limiting portion 222 and the first supporting portion 211. At least one side of the second position-limiting portion 222 in the second direction Y protrudes from the first position-limiting portion 221, and the second position-limiting portion 222 abuts against the top end 101 of the battery cell 10. A size of the battery cell 10 in the second direction Y is D, and in the second direction Y, a size of a part of the second position-limiting portion 222 covering the battery cell 10 in the first direction X is L, where 3/200≤D/L≤3/20. The first supporting portion 211, the second supporting portion 212, and the first position-limiting portion 221 and the second position-limiting portion 222 in each of the supporting members 21 are an integrated structure.

In a same projection plane perpendicular to the first direction X, an orthographic projection of the electrode terminal 13 is spaced apart from an orthographic projection of the first supporting portion 211, and an orthographic projection of the pressure relief mechanism 14 is spaced apart from the orthographic projection of the first supporting portion 211, and a groove 2101 is provided on a side of the second supporting portion 212 facing the battery cell 10, and the orthographic projection of the electrode terminal 13 falls into the groove 2101. The second supporting portion 212 further has a via hole connected to the groove 2101. The box body 30 includes a frame 32 and a bottom plate 31 that are connected and arranged. The drying assembly 42 is arranged between the second supporting portion 212 and the bottom plate 31. In the first direction X, the bottom plate 31 is arranged on the side of the second supporting portion 212 facing away from the battery cell 10. There is a gap between the supporting member 21 and the bottom plate 31, and the orthographic projection of the electrode terminal 13 overlaps with an orthographic projection of the via hole, and an orthographic projection of the via hole falls into the drying assembly 42. The frame 32 is connected to the supporting member 21 by stir friction welding and they enclose to form an accommodating space, and the battery cell 10 is accommodated in the accommodating space.

In the first direction X, a reinforcement structure 202 is protruded from the side of the second supporting portion 212 facing away from the battery cell 10, at least one side of each of the second supporting portions 212 in the second direction Y is provided with a reinforcement structure 202, and a reinforcement structure 202 is provided at a connection between any two adjacent supporting members 21 among the plurality of supporting members 21.

The second supporting portion 212 is further provided with a discharge hole 203, and the blocking member 44 is configured to be actuated by an emission discharged from the corresponding battery cell 10 toward the discharge hole 203, so as to open the discharge hole 203. The blocking member 44 includes a blocking portion 441 and a connecting portion 442. In the first direction X, the connecting portion 442 is connected to the side of the second supporting portion 212 facing the battery cell 10, the blocking portion 441 protrudes from the connecting portion 442 in the first direction X toward a side facing away from the battery cell 10, and the blocking portion 441 extends into the discharge hole 203. The flexible assembly 45 is arranged between the battery cell 10 and the second supporting portion 212 and encloses, together with the battery cell 10 and the second supporting portion 212, a discharge channel 451. The pressure relief mechanism 14 is in communication with the discharge hole 203 through the discharge channel 451.

It should be noted that, without conflict, embodiments in the present application and features in the embodiments may be combined together.

Finally, it should be noted that, the above embodiments are merely used for describing the technical solution of the present application, instead of limiting the present application; although the present application is described in detail with reference to the foregoing embodiments, persons of ordinary skill in the art should understand that they can still make modifications on the technical solution recorded in the above embodiments, or perform equivalent replacements on a part of technical features thereof; these modifications or replacements are not intended to make the essences of the corresponding technical solutions depart from the spirit and scope of the technical solutions of the embodiments of the present application.

What is claimed is:

1. A battery apparatus, comprising:
a battery cell, comprising an electrode terminal, wherein one end of the battery cell in a first direction is provided with the electrode terminal; and
a position-limiting assembly, comprising a supporting member, wherein in the first direction, the supporting member is located on a side of the electrode terminal facing away from the other end of the battery cell in the first direction, the supporting member has a first cavity, and the first cavity is configured to allow a first heat exchange medium to flow;
wherein in a same projection plane perpendicular to the first direction, an orthographic projection of the electrode terminal and an orthographic projection of the first cavity are spaced apart.

2. The battery apparatus according to claim 1, wherein the first direction is a height direction of the battery cell, in the first direction, the battery cell has a top end and a bottom end that are oppositely arranged, the electrode terminal is arranged at the bottom end of the battery cell, and the battery cell is supported by the supporting member.

3. The battery apparatus according to claim 1, wherein the supporting member comprises a first supporting portion and a second supporting portion interconnected in a second direction, the first supporting portion has the first cavity, in the first direction, the battery cell and the second supporting portion are spaced apart, a side surface of the first supporting portion facing the battery cell protrudes from a side surface of the second supporting portion facing the battery cell, and the first direction intersects with the second direction.

4. The battery apparatus according to claim 3, wherein in the same projection plane perpendicular to the first direction, the orthographic projection of the electrode terminal and an orthographic projection of the first supporting portion are spaced apart.

5. The battery apparatus according to claim 3, further comprising:
a first heat-conducting structure, wherein the first heat-conducting structure is arranged between the first supporting portion and the battery cell, and the battery cell is connected to the first supporting portion through the first heat-conducting structure.

6. The battery apparatus according to claim 3, wherein the supporting member is one of a plurality of supporting members welded in sequence in the second direction, and the first supporting portion and the second supporting portion in each of the supporting members are an integrated structure.

7. The battery apparatus according to claim 3, wherein in the first direction, a groove is provided on a side of the second supporting portion facing the battery cell, and the orthographic projection of the electrode terminal falls into the groove.

8. The battery apparatus according to claim 7, wherein in the first direction, the second supporting portion has a first surface and a second surface that are oppositely arranged, the first surface is arranged facing the battery cell, the groove is recessed from the first surface toward the second surface, and a protruding portion protruding from the second surface is formed at a position of the second supporting portion corresponding to the groove.

9. The battery apparatus according to claim 7, wherein the second supporting portion has a via hole in communication with the groove.

10. The battery apparatus according to claim 9, wherein in the same projection plane perpendicular to the first direction, the orthographic projection of the electrode terminal overlaps with an orthographic projection of the via hole.

11. The battery apparatus according to claim 9, further comprising:
a box body, wherein the battery cell and the supporting member are both arranged in the box body, the box body comprises a bottom plate, in the first direction, the bottom plate is arranged on a side of the supporting member facing away from the battery cell, and there is a gap between the via hole and the bottom plate.

12. The battery apparatus according to claim 11, further comprising:
a drying assembly, wherein in the first direction, the drying assembly is arranged between the second supporting portion and the bottom plate, and the orthographic projection of the via hole falls in the drying assembly.

13. The battery apparatus according to claim 11, wherein the box body further comprises a frame, the frame is welded to the supporting member and they enclose to form an accommodating space, and the battery cell is accommodated in the accommodating space.

14. The battery apparatus according to claim 13, wherein the bottom plate is connected to the frame, and/or, in the first direction, there is a gap between the supporting member and the bottom plate.

15. The battery apparatus according to claim 3, wherein:
the battery cell further comprises a pressure relief mechanism, in the first direction, the pressure relief mechanism is arranged at one end of the battery cell facing the electrode terminal, and the pressure relief mechanism is configured to discharge an emission in the battery cell; and
in the same projection plane perpendicular to the first direction, an orthographic projection of the pressure relief mechanism and the orthographic projection of the first cavity are spaced apart.

16. The battery apparatus according to claim 15, wherein the second supporting portion is provided with a weak portion, and the weak portion and the pressure relief mechanism are arranged oppositely in the first direction.

17. The battery apparatus according to claim 16, wherein the weak portion is a discharge hole passing through the second supporting portion.

18. The battery apparatus according to claim 17, further comprising:
a blocking member, wherein the blocking member is connected to a side of the second supporting portion facing the battery cell in the first direction, the blocking member covers the discharge hole, and the blocking member is configured to be actuated by the emission discharged from the corresponding battery cell toward the discharge hole, so as to open the discharge hole.

19. The battery apparatus according to claim 18, wherein the blocking member comprises a blocking portion and a connecting portion, the connecting portion is connected to the second supporting portion, the blocking portion protrudes from the connecting portion in the first direction toward a side facing away from the battery cell, and the blocking portion extends into the discharge hole.

20. An electrical device, comprising the battery apparatus according to claim 1.
